(19) United States
(12) Patent Application Publication
(10) Pub. No.: US 2015/0054826 A1
(43) Pub. Date: Feb. 26, 2015

(54) AUGMENTED REALITY SYSTEM FOR IDENTIFYING FORCE CAPABILITY AND OCCLUDED TERRAIN

(71) Applicant: Kenneth Varga, Phoenix, AZ (US)

(72) Inventor: Kenneth Varga, Phoenix, AZ (US)

(73) Assignee: REAL TIME COMPANIES, Phoenix, AZ (US)

(21) Appl. No.: 14/480,301

(22) Filed: Sep. 8, 2014

Related U.S. Application Data
(63) Continuation-in-part of application No. 13/385,039, filed on Jan. 30, 2012, now abandoned.
Application No. 13/385,039 is a continuation-in-part of application No. 14/271,061, filed on May 6, 2014.
Application No. 14/271,061 is a continuation-in-part of application No. 12/460,552, filed on Jul. 20, 2009, now abandoned.
Application No. 12/460,552 is a continuation-in-part of application No. 12/383,112, filed on Mar. 19, 2009, now abandoned.
(60) Provisional application No. 61/626,701, filed on Sep. 30, 2011.
(60) Provisional application No. 61/629,043, filed on Nov. 12, 2011.

(51) Int. Cl. G06T 17/05; G06T 15/00; G06T 15/40

(52) U.S. Cl. CPC G06T 17/05; G06T 15/40; G06T 15/005; G06T 2215/16; G06T 2210/64
USPC 345/421

(57) ABSTRACT

An occlusion or unknown space volume confidence determination and planning system using databases, position, and shared real-time data to determine unknown regions allowing planning and coordination of pathways through space to minimize risk is disclosed. Data from a plurality of cameras, or other sensor devices can be shared and routed between units of the system. Hidden surface determination, also known as hidden surface removal (HSR), occlusion culling (OC) or visible surface determination (VSD), can be achieved by identifying obstructions from multiple sensor measurements and incorporating relative position with depth between sensors to identify occlusion structures. Weapons ranges, and orientations are sensed, calculated, shared, and can be displayed in real-time. Data confidence levels can be highlighted from time, and frequency of data. The real-time data can be displayed stereographically for and highlighted on a display.

### CROSS REFERENCE TO RELATED APPLICATIONS

This application is a continuation-in-part and claims benefit to U.S. patent application Ser. No. 13/385,039 filed on Jan. 30, 2012, which claims benefit to U.S. provisional application Ser. No. 61/629,043 filed on Nov. 12, 2011 and U.S. provisional application Ser. No. 61/626,701, filed on Sep. 30, 2011, as well as U.S. patent application Ser. No. 14/271,061 filed on May 6, 2014, which claims benefit to U.S. patent application Ser. No. 12/460,552, filed on Jul. 20, 2009, which is claims benefit to U.S. patent application Ser. No. 12/383,112, which are herein incorporated by reference in their entirety.

### BACKGROUND

Aspects of the present disclosure involve real-time identification of critical force capability effectiveness zones and occlusion or unknown zones near those forces. Personnel, vehicles, ships, submarines, airplanes, or other vessels are often occluded by terrain surfaces, buildings, walls, or weather, and sensor systems may be incapable of identifying objects on the other sides of the occlusions, or objects may simply be outside of range of sensors or weapons capabilities. Users, such as field commanders may use the system described herein to identify the occlusion zones, track targets amongst occlusions, as well as threat ranges from these occlusion zones, in advance of force actions, and to share the data between systems in real-time to make better more informed decisions.

One example of this problem of individual human perception can be well illustrated by the 1991 Battle of 73 Easting during the first Gulf War during adverse weather conditions that severely restricted aerial scouting and cover operations. Although successful for the U.S. side, asymmetrical force risk was higher than necessary because although it appeared to be a flat featureless desert, the occluding subtle slight slope of the terrain was not initially recognized to occlude visual battlefield awareness by a tank commander named HR McMaster. The subtle slight land slope occlusion prevented identifying awareness of critical real-time data of enemy numbers, positions, and capabilities in the absence of advanced aerial reconnaissance due to severe weather conditions.

Aspects of the present disclosure enable users more acutely aware of sloped or other terrain or regions that are outside their field of visual, perceptual or sensory awareness of which can contain fatal hazards, particularly when these zones have not been scouted for hazards in real-time. Users can then adjust their actions to eliminate or avoid the hazards of the occlusion zones. The limitation of the perceptual capability of one pair of human eyes and one pair of human ears on an individual or mobile unit can be reduced by utilizing multiple users remotely tapped into one user's omni-directional sensor system(s) and can thus maximize their perceptual vigilance and capability of the one user or unit through remote robotic control and feedback of the individual or unit carried sub-systems. Maximized perceptual vigilance can be achieved from tapping into near full immersion sensors, which can include sensing vision three dimensional (3D) display from depth cameras (optics), temperature, stereo or surround or zoom-able microphone systems, pinching, poking, moisture, vestibular balance, body/glove sensation while producing an emulated effect of this remotely producing nearly full sensory immersions. Tracking, history, force capability, prediction, as well as'other data can be augmented onto the display system to augment reality and to further enhance operations.

### SUMMARY

Various aspects of the present disclosure allow for identifying the real-time range capability of a force or forces, their weapons, real-time orientation (pointing direction) of weapons (with integrated orientation sensors on weapons) and weapons ranges, equipment or other capabilities, as well as sensor and visual ranges during multiple conditions of night and day and varying weather conditions. From identified real-time zone limitations based on weapons ranges, occlusions, terrain, terrain elevation/topographical data, buildings, ridges, obstructions, weather, shadows, and other data, field commander decisions are able to be made more acutely aware of potential hazard zones, to avoid or make un-occluded and aware of, and be better prepared for in order to reduce operational risks. The system can be designed to implement real-time advanced route planning by emulating future positions and clarifying occlusions and capabilities in advance, thus allowing for optimal advanced field positioning to minimize occlusion zones, avoid hazards from, and maximize situational awareness.

### DETAILED DESCRIPTION OF THE DRAWINGS

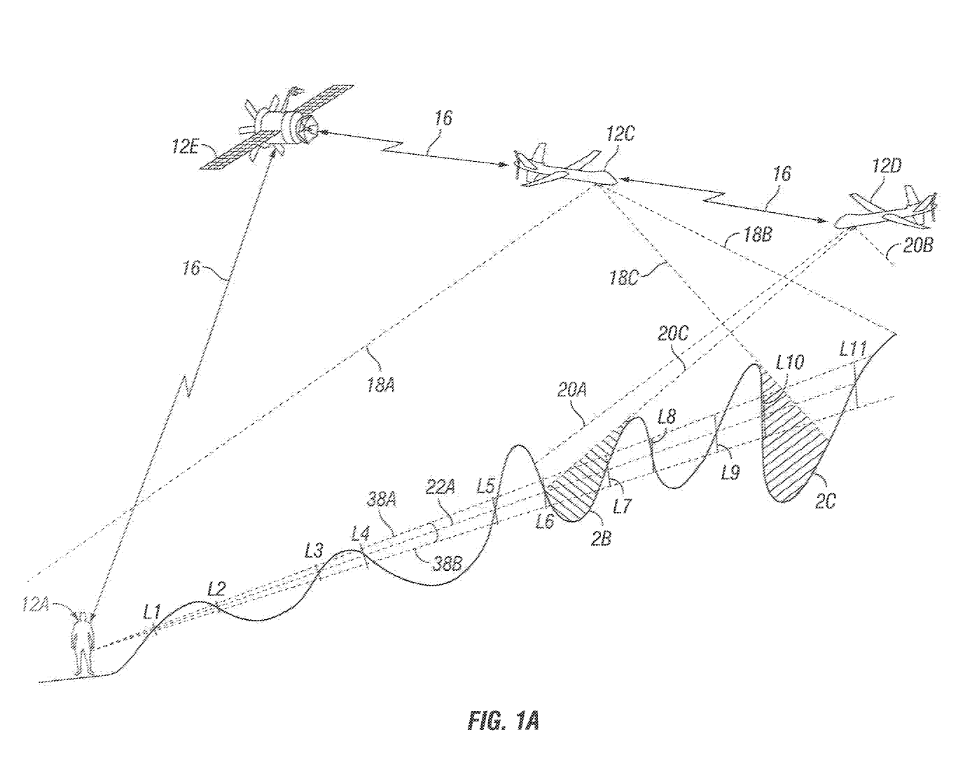

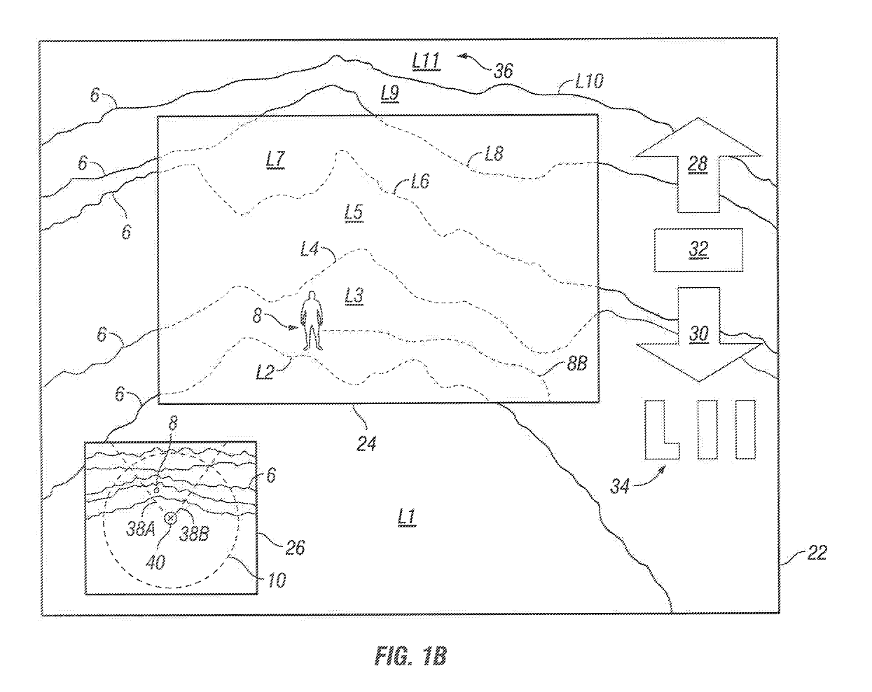

FIG. 1A is an example of the occlusion problem of a mountainous region with many mountain ridges (layers) and illustrates how the occluded zones can be identified and viewed via real-time wireless information sharing between multiple units.

FIG. 1B is a real-time Heads-Up Display (HUD) of occlusion layer viewing penetration of mountain ridges of FIG. 1A that allows the operator to look through and control the viewing layers of occlusion to see through the mountain layers, according to one embodiment.

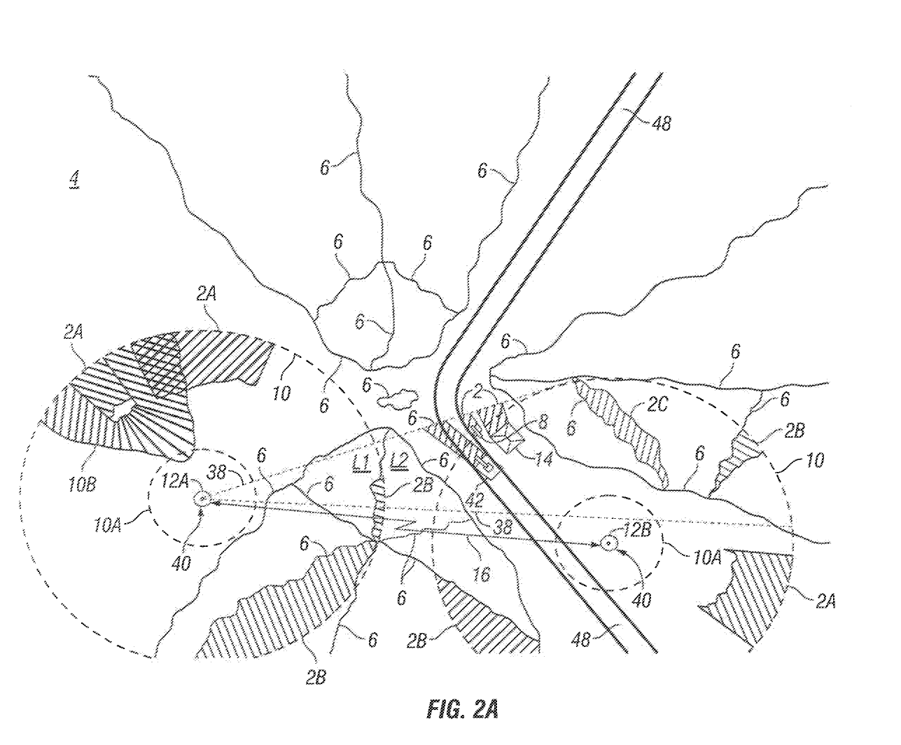

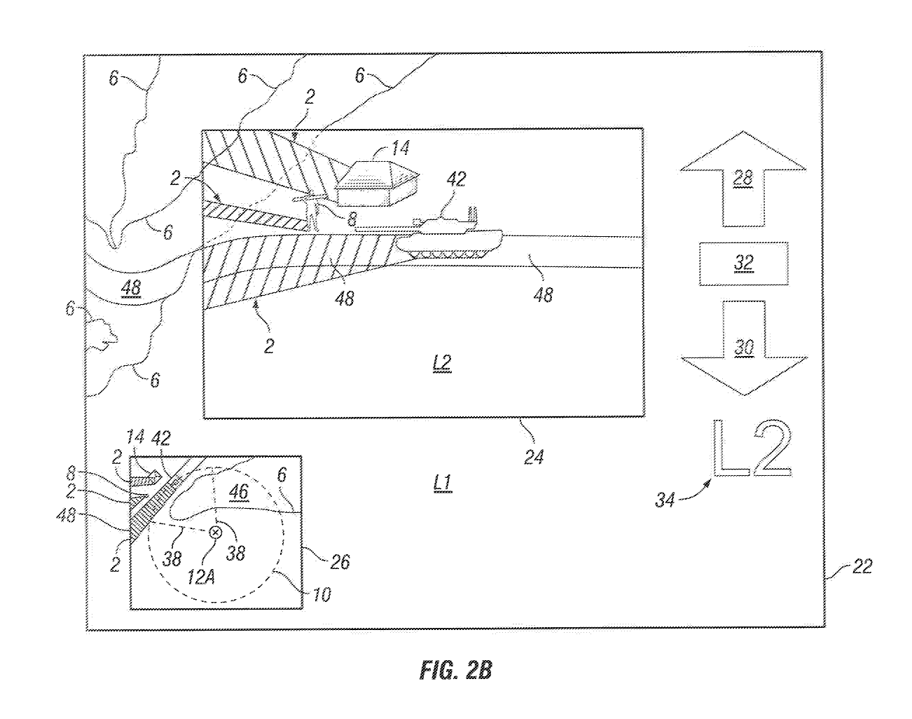

FIG. 2A is a real-time battlefield force capability and occlusion hazard awareness map showing weapon range capabilities and unit occlusions, according to one embodiment.

FIG. 2B is a real-time HUD of occlusion layer viewing penetration of the mountain ridge of FIG. 2A that utilizes transformed image data from other unit with other unit's occlusion zones shown, according to one embodiment.

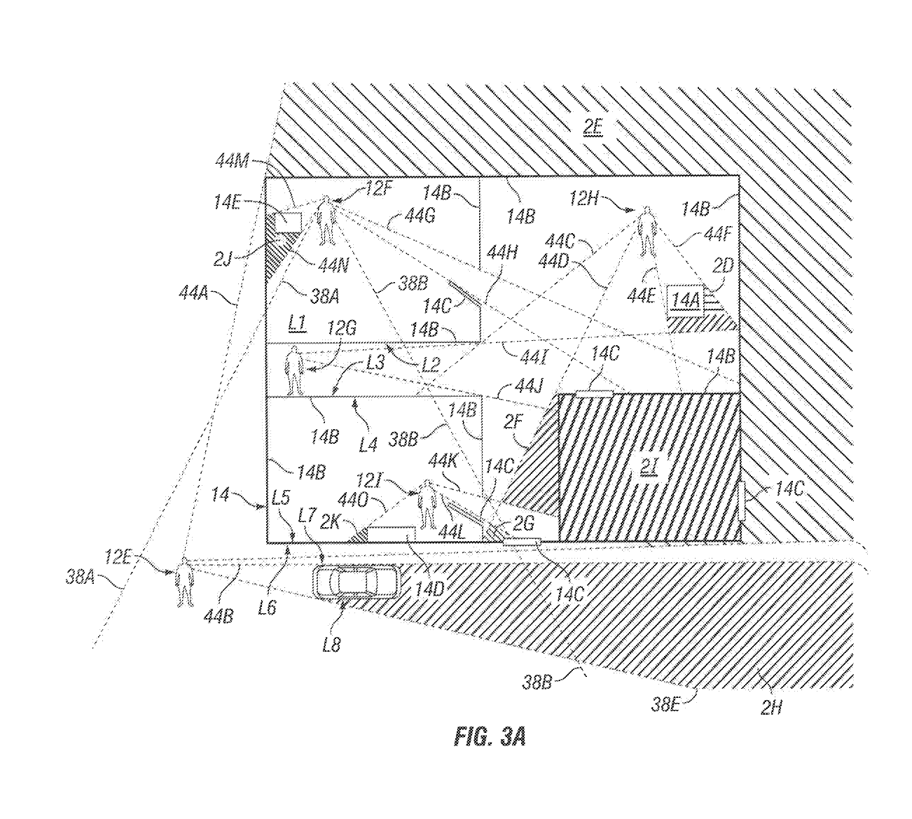

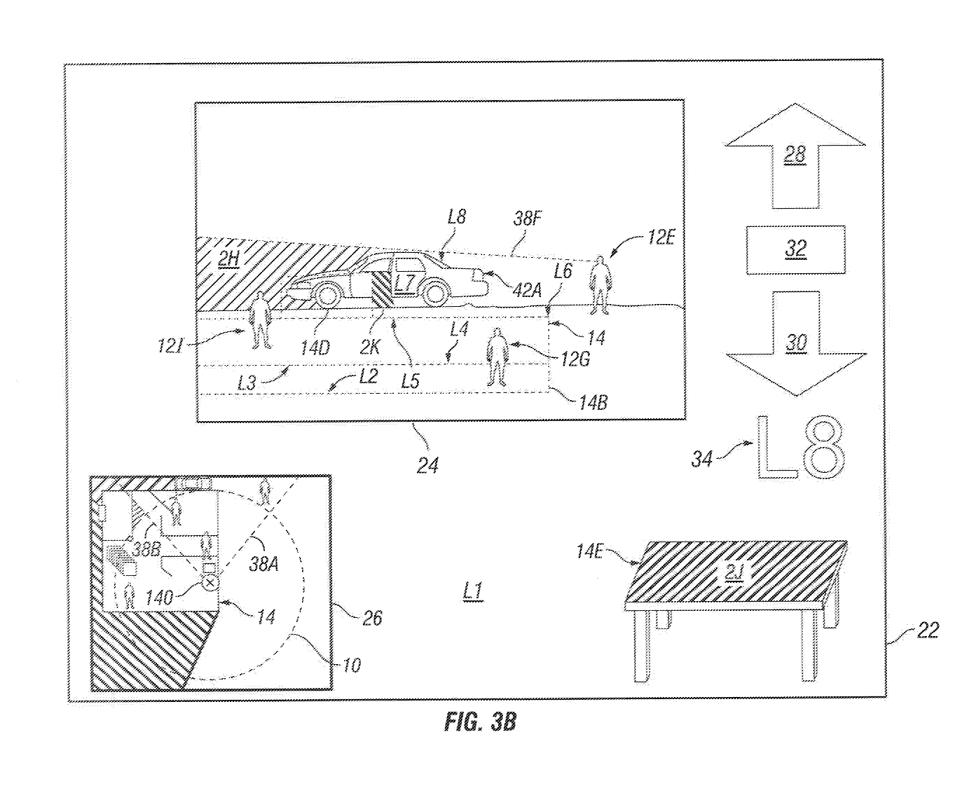

FIG. 3A is a real-time building search where multiple personnel are searching rooms and sharing data where un-identified regions are shown, according to one embodiment.

FIG. 3B is a real-time HUD of occlusion layer viewing penetration of building walls of FIG. 3A that utilizes transformed image data from other units, according to one embodiment.

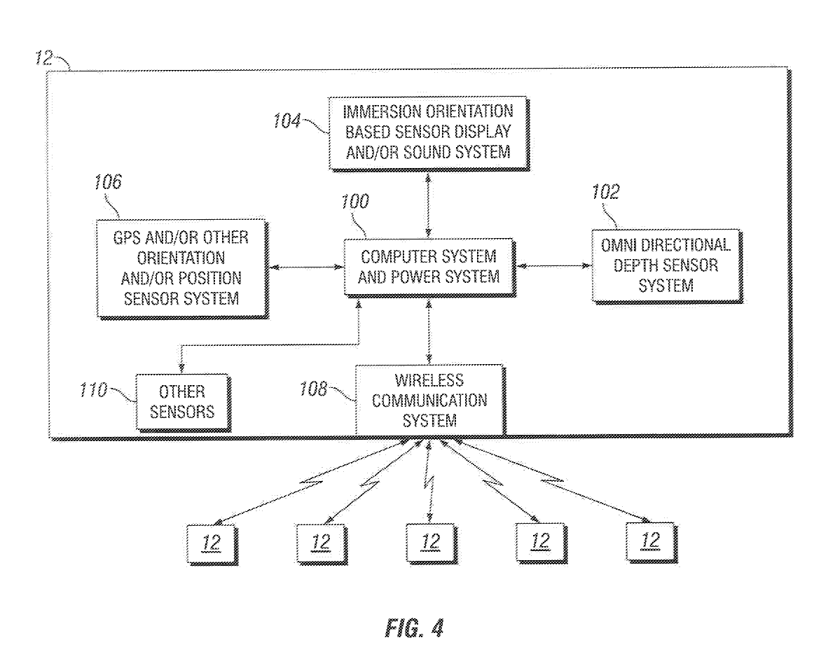

FIG. 4 is a block diagram of the environment extra-sensory perception sharing system hardware, according to one embodiment.

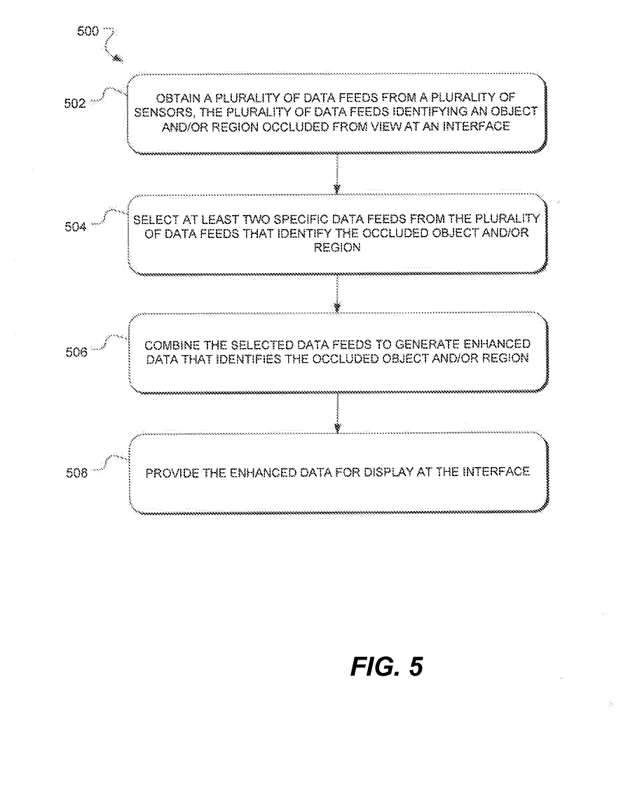

FIG. 5 is a flow chart for identifying an occluded object included within an occluded region or space, according to one embodiment.

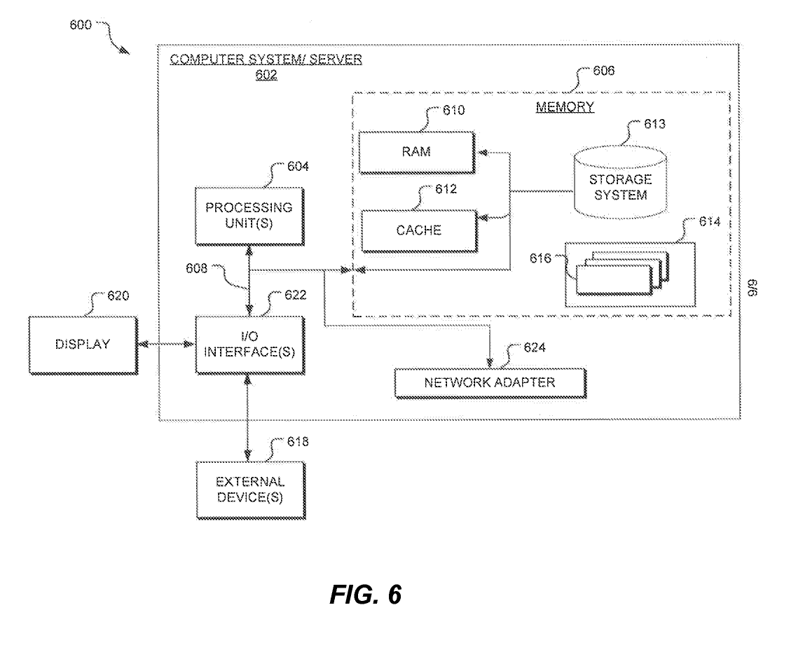

FIG. 6 is a block diagram of a computing system, according to one embodiment.

### DETAILED DESCRIPTION

FIG. 1A shows a planar slice of a hilly mountainous terrain 6 with many occluding (blocking) valley layers labeled as “L1 through L11” viewed by person 12A where layer “L1” is not occluded to person 12A. These layers L2 through L11 can create significantly occluded regions from the unaided perspective view of a dismounted (on foot) person 12A shown. Unknown friends, foes, or other objects, can reside in these occluded spaces in real-time and can have an element of surprise that can have a significant impact on the performance objectives of a dismounted person 12A when what is in these regions in real-time is not known. When the dismounted person 12A looks at the hilly terrain 6, with his or her unaided eyes only, the dismounted person 12A can only see surface layer L1 while the layers L2 through L11 are significantly blocked (occluded). When the dismounted person 12A has the extra-sensory perception sharing system 12 (block diagram shown in FIG. 4) that uses a Heads Up Display (HUD) that can also be a hand held device with orientation sensors and head tracking sensors or a Head Mounted Display (HMD), many or all of the occluded layers can be viewed by the dismounted person 12A depending on what other force capability and unknown terrain identification systems are within communications range of each other. The occluding layers can have their images transferred from extra-sensory perception sharing system 12 (block diagram shown in FIG. 4) units and transformed into the perspective of dismounted person 12A viewing edges 38A and 38B. For occluding surfaces L2, L4, L6, L8, and L10 the image displayed can be reversed and transformed from the sensor perspective such that the viewing is as if the mountain were transparent, while surfaces L3, L5, L7, L9, and L11 do not need to be reversed because the sensor perspective is from the same side as the dismounted person 12A.

The regions that are occluded, and that are also not in real-time view of any extra-sensory perception sharing system 12, need to be clearly identified so that all participating systems are made well aware of the unknown zones or regions. These unknown regions can be serious potential hazards in war zones or other situations and need to be avoided or be brought within real-time view of a unit using a three dimensional (3D) sensor system which can be a omni-camera, stereoscopic camera, depth camera, “Zcam” (Z camera), RGB-D (red, green, blue, depth) camera, time of flight camera, radar, or other sensor device or devices and have the data shared into the system. In order to share the data the unit can have the extra-sensory perception sharing system 12 but do not need to have an integrated onboard display, because they can be stand alone or remote control units.

From the “x-ray like” vision perspective of person 12A (“x-ray like” meaning not necessarily actual X-ray, but having the same general effect of allowing to see through what is normally optically occluded from a particular viewing angle) the viewable layers of occlusion L2 through L11 have a planar left and right HUD viewing angles with center of the Field Of View (FOV) of the HUD display are shown by 38A, 38B, and 22A respectively.

The “x-ray like” vision of person 12A of the occluded layers L2 through L11 can be achieved by other extra-sensory perception sharing systems 12 units that are within communications range of person 12A or within the network, such as via a satellite network, where person 12A can communicate with using extra-sensory perception sharing system 12 (FIG. 4), where camera image data or other sensor data can be transferred and transformed based on viewing angle and zoom level. Shown in FIG. 1A is satellite 12E in communications range of person 12A where person 12A can communicate with satellite 12E using extra-sensory perception sharing system 12 (shown in FIG. 4) using wireless satellite communications signal 16. In the illustrated embodiment, satellite 12E is in communications with drone 12C to the left of FIG, although it is contemplated that drones 12C and 12D may receive information and/or data using various other communication networks, such as a radio link . . . 1A that has left planar edge sensor view 18A and right planar edge sensor view 18B. The part of the hilly mountainous terrain 6 that has a ridge between layers L9 and L10 creates a real-time occlusion space 2C for left drone 12C where occlusion plane edge 18C of left drone 12C is shown where real-time sensor data is not known, and thus can be marked as a hazard zone between L10 and L11 if all participating extra-sensory perception sharing systems 12 cannot see this space 2C in real-time. The hilly mountainous terrain 6 where left drone 12C is occluded from seeing space 2C in real-time, prior satellite or other reconnaissance data can be displayed in place, weighted with time decaying magnitude of confidence based on last sensor scan over this space 2C. If there is no other extra-sensory perception sharing systems 12 that can see (via sensor) space 2C in real-time then this space can be clearly marked as unknown with a time decaying confidence level based on last sensor scan of space 2C.

A field commander can, out of consideration of potential snipers, or desire to enhance knowledge of unknown space 2C can call in another drone 12D to allow real-time sensor coverage of space 2C and transfer data to other extra-sensory perception sharing systems 12, thus creating the ability of making space 2C potentially less of an unknown to other extra-sensory perception sharing systems 12 in the area and can be marked accordingly. Since in FIG. 1A the right drone 12D is in un-occluded (not blocked) view of space 2C with right drone 12D left edge sensor field of view 20A and right drone 12D right edge sensor field of view 20B, region 2C can be scanned in real-time with right drone 12D sensor(s) and this scanned data of space 2C can be shared in real-time with other extra-sensory perception sharing systems 12 and no longer has to be marked as significantly unknown. Right drone 12D has its own sensor occluded space 2B shown between part of the hilly mountainous terrain 6 that has a valley between layers L6 and L7 but because left drone 12C is in real-time view of space 2B the left drone 12C can share real-time sensor data of this space 2B with right drone 12D through wireless signal 16 as well as with person 12A through wireless signal 16 to/from left drone 12C and to/from satellite 12E using wireless signal 16 and down to person 12A through wireless signal 16 through satellite 12E. Space 2C data can also be shared between extra-sensory perception sharing systems 12 in a similar manner, thus eliminating most all occluded space for person 12A enabling person 12A to see all the occluded layers L2 through L11. If a drone moves out of view of any layer in real-time, this layer can be marked accordingly as out of real-time view by any means to make it clear, such as changing transparent color or any other suitable method to identify unknown space in real-time. Alarms can also be sounded when coverage drops unknown space increases within expected enemy firing range. Unknown spaces can show last scan data, but are clearly marked and/or identified as not real-time. If a possible target is spotted, such as via infrared signature, and it moves out of sensor range, an expanding surface area of unknown location can be marked and displayed until next ping (signature spotting) of target.

FIG. 1B shows the Heads Up Display (HUD) or Head Mounted Display (HMD) perspective view of the person 12A shown in FIG. 1A of the hilly mountainous terrain 6 edges with occluding layers L1 through L11 shown clear except for layer L4 and layers up to “L11” are available for viewing. The person 12A can select either side of the ridge to view, where the side of the occluded saddle (or dip) in the mountainous space 6 facing opposite of person 12A can have the reverse image layered onto the mountain surface, while the side of the saddle farthest can have the image layered onto the mountain surface as if seen directly. Individual layers can be selected, merged, or have a filtered view with just objects with certain characteristics shown such as objects that have a heat signature as picked up by an infrared (IR) camera or other unique sensor, or objects that have detected motion, or are picked up by radar or any other type of desired filtered object detected by a sensor of suitable type. Tracked targets inside occlusion layers can be highlighted, and can show a trail of their previous behavior as detected in real-time. On occlusion layer L4, sniper 8 is shown as discovered, tracked, and spotted with trail history 8B. If drone 12D (of FIG. 1A) was not present, unknown occluded zone 2C (of FIG. 1A) between layers L10 and L11 can be marked as unknown with a background shading, or any other appropriate method to clarify as an unknown region in “x-ray” like viewing area 24 or elsewhere or by other means in FIG. 1B. For example, an alarm may be activated when the system loses track of a target within the L10 and L11 zones. In yet another example, information corresponding to a target with the layers L10 and L11 may be provided, such as last known position of the target, known max velocity for the target, and terrain type.

FIG. 2A shows a mountainous terrain with three canyon valleys merged together where two person units, 12A and 12B, are shown. Unit 12A on the left of the figure, and one unit 12B, on the right of the figure are displayed with their sensor range capabilities as a dotted lined circle 10. Units 12A and 12B also display their weapons range capability as illustrated by the dotted circles 10A around the unit centers 40. Possible sniper 8 positions within occluded zone 2A next to unit 12A are shown with their corresponding predicted firing range space capabilities 10B. If a fix on a sniper 8 or other threat is identified, the real firing range space capability can be reduced to the range from real-time fix.

This map of FIG. 2A is only shown in two dimensions but can be displayed in a Heads Up Display (HUD) or other display in three dimensions and in real-time as well as display future probable movements for real-time adaptive planning. The system can display firing range 10B from occluded edges if the weapons held by an adversary have known ranges, by taking each occluded edge point for each point along the edge and drawing an arc range on its trajectory based on terrain and even account for wind conditions. By drawing the weapon ranges 10B, a unit can navigate around these potentially hazardous zones. Small slopes in land, or land bumps, rocks, or other terrain cause occlusion zones 2A (shown as shaded), as well as convex mountain ridges 6 produce occlusion zones 2B as well as occlusions from side canyon gaps 2C. Units 12A and 12B are able to communicate, cooperate, and share data through wireless signal 16 that can be via a satellite relay/router or other suitable means and can be bidirectional. Concave mountain ridges 6 generally do not produce occlusion zones 2 as shown on the two ridges 6 between units 12A and 12B where wireless signal 16 is shown to pass over.

Unit 12A on the left of FIG. 2A is shown with HUD viewing edges 38 (HUD view is shown in FIG. 2B) looking just above unit 12B in FIG. 2A where occlusion layers L1 and L2 are shown, where L1 occludes view from unit 12B while L1 is visible by unit 12A. Occlusion layer L2 is viewable by unit 12B and is occluded by unit 12A. Near unit 12B is road 48 where a tank 42 casts an occlusion shadow 2. By tank 42, a building 46 and a person on foot 44 are also in view of unit 12B but also cast occlusion shadows 2 from unit 12B sensor view. The occluded unknown regions 2, 2A, 2B, and 2C are clearly marked in real-time so users of the system can clearly see regions that are not known.

In FIG. 2B a see through (or optionally opaque if desired) HUD display 22 with “X-ray” like view 24 that penetrates the occlusion layer L1 to show layer L2 using real-time perspective image transformation that would otherwise be blocked by mountain edge 6 where the tank 42 on road 48, person with weapon 8, and building 14 cast sensor occlusion shadows 2 marking unknown zones from sensor on unit 12B (of FIG. 2A). A field commander can use these occlusion shadows that are common amongst all fielded units to bring in more resources with sensors that can contribute to system knowledge to eliminate the occlusion shadows 2 thus reducing the number of unknowns, and reducing operational risks. An example birds-eye (overhead) view map 26 around unit 12A is shown in FIG. 2B with tank 42 on road 48 within unit 12A sensor range 10 along with person with weapon 8 and building 14 shown. Example occlusion layer controls and indicators are shown as 28, 30, 32, and 34, where as an example, to increase occlusion views level, of viewing arrow 28 is selected, or to decrease occlusion view level arrow 30 is selected, or to turn display off or on 32 is selected. The maximum occlusion levels available are indicated as “L2” 34.

Shown in FIG. 3A is an example two dimensional (2D) view of a building 14 floor plan with walls 14B and doors 14C being searched by four personnel 12F, 12G, 12H, and 121 inside the building and one person 12E outside of the building 14 all communicating wirelessly (wireless signals between units are not shown for clarity). The inside person 12F is using the HUD “x-ray” like view (as shown in FIG. 3B) with “x-ray” view edges 38A and 38B starting from inside occlusion layer L1 formed by room walls. Inside person 12F has occlusion view edges 44G and 44H caused by door 14C that identifies viewable space outside the room that inside person 12F is able to see or have sensors see. Inside person 12G is shown inside hallway where occlusion layer L2 and L3 is shown with respect to inside person 12F with occlusion edges 441 and 44J caused by wall 14B room corners. Inside person 12H is shown outside door of where person 12F is with occluded view edges identified as dotted lines 44C and 44D caused by room corners and 44E caused by building column support 14A and 44F also caused by building column support 14A. Person 121 next to cabinet 14D is shown inside occlusion layers L4 and L5 relative to person 12F with occlusion edges 44K and 44L caused by door 14C. Outside car 42A is shown as occlusion layer L7 and L8 as car edge nearest building 14 relative to inside person 12F. Each time a layer is penetrated from a line-of-sight ray-trace relative to an observer with an extra-sensory perception system 12, two layers of occlusion is added where perspective transformed video from each side of the occlusion can be shared within the systems.

Unknown regions of FIG. 3A that are occluded by all the personnel are identified in real-time as 2D, 2E, 2F, 2G, 2H, 21, 2J, and 2K. These regions are critical for identifying what is not known in real-time, and are determined by three dimensional line-of-sight ray-tracing of sensor depth data (such as by 3D or-ing/combining of depth data between sensors with known relative orientations and positions). Data from prior scan exposures of these regions can be provided but clearly marked as either from semi-transparent coloring or some other means as not real-time viewable. Occluded region 2J is caused by table 14E near person 12F and is occluded from the viewing perspective of person 12F by edges 44M and 44N. Occlusion 2D is caused by building support column 14A and is shaped in real-time by viewing perspective edges 44E and 44F of sensors on person 12H as well as sensor viewing perspective edges 441 and 44J of person 12G. Occlusion space 2F is formed by perspective sensor edges 44K and 44L of person 121 as well as perspective sensor edge 44D of person 12H. Occlusion space 2K is caused by cabinet 14D and sensor edge 440 from person 121. Occlusion space 21 is formed by room walls 14B and closed door 14C. Occlusion space 2G is formed by perspective sensor edges 44L and 44K of person 121 and perspective sensor edge 44D of person 12H. Occlusion space 2H is caused by car 42A and perspective sensor edge 44B from outside person 12E along occlusion layer L7 as well as sensor edge 38E. Occlusion space 2E is caused by perspective sensor edge 44A from outside person 12E touching building 14 corner.

The occlusion regions are clearly marked in real-time so that personnel can clearly know what areas have not been searched or what is not viewable in real-time. The system is not limited to a single floor, but can include multiple floors, thus a user can look up and down and see through multiple layers of floors, or even other floors of other buildings, depending on what data is available to share wirelessly in real-time and what has been stored within the distributed system. A helicopter with the extra-sensory perception sharing system 12 hovering overhead can eliminate occluded regions 2E and 2H in real-time if desired. Multiple users can tap into the perspective of one person, say for example, inside person 12H, where different viewing angles can be viewed by different people connected to the system so as to maximize the real-time perceptual vigilance of person 12H. To extend the capability of inside person 12H robotic devices that can be tools or weapons with capabilities of being manipulated or pointed and activated in different directions can be carried by person 12H and can be remotely activated and controlled by other valid users of the system, thus allowing remote individuals to “watch the back” or cover person 12H. Alternatively, a stereographic spherical camera may be triggered or otherwise remotely activated by various users of the system to “watch the back” of person 12H.

In FIG. 3B a see-through HUD display view 22 is shown with “x-ray” like display 24 showing view with edges defined by 38A and 38B from person 12F of FIG. 3A where all occlusion layers L1 through L8 are outlined and identified with dotted lines and peeled away down to L8 to far side of car 42A with edge of car facing building 14 shown as layer L7 with semi-transparent outlines of tracked/identified personnel 121 and 12G inside the building 14 and person 12E outside the building 14. Shown through the transparent display 22 is table 14E inside room where person 12F resides. Semi-transparent outline of cabinet 14D is shown next to car 42A with occlusion zone 2K shown. A top level (above head) view of the building 14 floor plan 26 is shown at the bottom left of the see-through display 22 with inside person 12F unit center 40 range ring 10 which can represent a capability range, such as a range to spray a fire hose based on pressure sensor and pointing angle, or sensor range limit or other device range limit. The building 14 floor plan is shown with all the other personnel in communications range inside the top level (above head) view 26 of the floor plan. Occlusion layer display controls are shown as 28 (up arrow) to increase occlusion level viewing, 30 (down arrow) to decrease occlusion level viewing, and display on/off control 32 and current maximum occlusion level available 34 shown as L8.

FIG. 4 is an example hardware block diagram of the extra-sensory perception sharing system 12 that contains a computer system (or micro-controller) with a power system 100. Also included is an omni-directional depth sensor system 102 that can include an omni-directional depth camera, such as an omni-directional RGB-D (Red, Green, Blue, Depth) camera or a time of flight camera, or Z-camera (Z-cam), or a stereoscopic camera pairs, or array of cameras. The extra-sensory perception sharing system 12 can be fixed, stand alone remote, or can be mobile with the user or vessel it is operating on. The Omni-directional depth sensor system 102 is connected to the computer and power system 100. A GPS (Global Positioning System) and/or other orientation and/or position sensor system are connected to computer system and power system 100 to get relative position of each unit. Great accuracy can be achieved by using differential GPS or highly accurate inertial guidance devices such as laser gyros where GPS signals are not available. Other sensors 110 are shown connected to computer system and power system 100 which can include radar, or actual X-ray devices, or any other type of sensor useful in the operation of the system. Immersion orientation based sensor display and/or sound system 104 is shown connected to computer system and power system 100 and is used primarily as a HUD display, which can be a Head Mounted Display (HMD) or hand held display with built in orientation sensors that can detect the device orientation as well as orientation of the user's head. A wireless communication system 108 is shown connected to computer system and power system 100 where communications using wireless signals 16 are shown to connect with any number of other extra-sensory perception sharing systems 12. Data between extra-sensory perception sharing systems 12 can also be routed between units by wireless communications system 108.

FIG. 5, with reference to FIGS. 1A, provides an illustrative process and/or method for performing real-time identification of occluded regions, and/or the identification of occluded objects included within an occluded region. In particular, FIG. 5 illustrates an example process 500 for identifying one or more objects that may be occluded from the view of a user interacting with an interface, such as a HUD, due to the fact that the object may be within a region or area that is occluded from the view of the user interacting with the interface.

As illustrated, process 500 begins with obtaining a plurality of data feeds that identify an object and/or region or a real-world environment that is occluded from view at an interface (operation 502).

Referring to FIG. 1, various data feeds and/or data may be obtained from various sensors located on and/or otherwise within various data systems, such as the satellite 12E, and/or the drones 12C or 12D, capable of capturing terrains, objects, weather, and/or other data corresponding to the occluded object and/or region. For example, a user may access the drone 12D to obtain real-time sensor coverage of space 2C, thus creating the ability of making space 2C potentially less of an unknown to person 12A. Since in FIG. 1A the drone 12D is in un-occluded (not blocked) view of space 2C, region 2C can be scanned in real-time with right drone 12D sensor(s) and the data of space 2C, and therefore be, no longer marked as unknown or occluded. Although FIG. 1 only includes three data systems (e.g., the satellite 12E, and/or the drones 12C or 12D) it is contemplated that many more may be involved in the capturing of data and/or data feeds corresponding to the occluded object and/or region.

The data feeds may be obtained from various types of sensors, such as an omni-cam-era, stereoscopic camera, depth camera, “Zcam” (Z camera), RGB-D (red, green, blue, depth) camera, time of flight camera, radar, or other type of sensor. And the obtained data feeds may be captured in a variety of formats. For example, the data feeds may include audio, video, three-dimensional video, images, multimedia, and/or the like, or some combination thereof. In one particular embodiment, one or more of the data feeds may be obtained from an airborne warning and control system (AWAC) (e.g., drone 12C), and according to the AWAC data format, as is generally understood in the art (a mobile, long-range radar surveillance and control centre for air defense).

Referring again to FIG. 5, once any data feeds corresponding to the sensors has been obtained, specific data feeds may be selected that best identify the object occluded from the view and/or the region occluded from view. Stated differently, some data feeds may be more useful in identifying the occluded objects and/or regions than other data feeds. Referring again to FIG. 1A, assume three different data feeds are obtained: one from the drone 12D, one from the drone 12C and one from the satellite 12E. Additionally, assume that each data feed is obtained in a different format than the other. Thus, the data feed from the drone 12D may be in video format, while the data freed from the drone 12C may be in AWAC format.

According to one embodiment, the data feed from the drones 12C and 12D, when compared to the data feed obtained from the satellite 12E, may be more relevant to identifying specific objects included within the occluded region 2C because they have a potential direct line of sight to the region and the satellite 12E does not. Thus, the data feeds corresponding to the drones 12C and 12D may be identified and not the satellite 12E data feed. In another embodiment, since the data feeds are in different formats, some data may be more useful in uniquely identifying the occluded object than others. For example, data feeds that include high-resolution images may be more useful in uniquely identifying an object than a data feed that only provides geographical coordinates. As another example, if the format of the data feed is video, it may be more useful in identifying the actual object occluded from view and movement of the object, but not as useful when attempting to determine the specific geographic location of the object. In yet another example, if the data feed is of the AWAC format, the data may useful in providing a specific location of the occluded object, but not when attempting to uniquely identify the occluded object itself. For example, video may be more accurate in determining the exact types of weapons and ordinance that may be carried. Additionally, video may allow for a more accurate count of ground troops. Spherical video images allow for users to view the same data in different directions to get a more accurate real-time coverage. In comparison, AWAC data allows for precise latitude and/or longitude positioning, which would allow precision location that may be used to create velocity vectors for each individual target. Given a location identified via AWAC data, terrain position, and velocity vector predictions could be created as the target reaches a particular position thus providing the user with a tactical edge.

Referring back to FIG. 5, the selected data feeds may be combined together to generate enhanced data that is more accurate and clearly identifies the occluded object and/or region (operation 506). Stated differently, portions and/or aspects of the selected data feeds may be combined to generate enhanced data that precisely identifies, locates, and qualifies the occluded object.

According to one embodiment, to generate the enhanced data, each of the selected data feeds may be weighted (e.g., assigned a value) based upon various characteristics of the occluded region and/or the occluded object, and the accuracy of the data feed identifying the occluded region and/or occluded object. Further, the assigned weighting may, optionally, depend upon the current tactical mode in which a user is engaged. For example, if a user is looking to determine troop strength and weapons the user may assign a higher weighting to video data, because the video data may be more easily processed by stopping and/or stepping thru frames of the video to get an accurate count and tag the group with the appropriate strength/range attributes.

As another example, video may be more accurate in determining the exact types of weapons and ordinance that may be carried by soldiers in combat because the video data actually includes real images of the weapons and/or ordinance. Thus, the video data feed may be assigned a higher weight than other data feeds, in such contexts. In another embodiment, video may allow for a more accurate count of ground troops than infra-red data, and thus, would be assigned a higher weight that an infra-red data feed. In yet another embodiment, spherical video images allow for users to view the same data in different directions to get a more accurate real-time coverage. Such data may be weighted higher than static image data feeds. In one embodiment, AWAC data allows for precise latitude and/or longitude positioning, which would allow precision location that may be used to create velocity vectors and corresponding time stamps for each individual occluded object and/or region. Thus, AWAC data may be assigned a higher weighting when compared to video, when attempting to precisely locate an occluded object and/or region. In another embodiment, infra-red data feeds may be more accurate at identifying occluded objects and/or regions is wooded areas, as the data provides thermal images of objects that may not be visible in regular video data. In such a contexts, the Infra-red data feed would be assigned a higher weight than a video data, feed, image data feed, or other data feeds.

The assigned weightings of the various data feeds may change with time. For example, if a highly accurate and/or highly weighted sensor becomes unavailable then the next best sensor data is used and the user is notified of an accuracy degradation. If more accurate sensors become available the user is notified of an accuracy upgrade. The most accurate position would be a triangulation of two (2) or more sensors identifying the exact same location. This is downgraded to one sensor and further downgraded by sensors with less accuracy.

Once the data feeds have been weighted, the data may be enhanced by combining one or more of the weighted data feeds into an aggregate data feed and/or other type of display that clearly identifies an occluded region and/or an occluded object. In one embodiment, data that meets a weight threshold signifying a certain accuracy level and/or accuracy measure may be combined to generate the enhanced data. For example, video data feeds may be enhanced with actual terrain data (e.g., the terrain data may be overlayed with the video) to help identify potential critical traffic routes and bottlenecks allowing for strategic troop placement or demolition. It is contemplated that any number of data feeds satisfying the weighting threshold may be combined to generate the enhanced data.

The generated enhanced data, including data uniquely identifying the occluded object and/or region and data identifying a location of the occluded object and/or region may be provided to an interface for display (operation 508). In one particular embodiment, the enhanced data may be rendered or otherwise provided in real-time in a three-dimensional stereographic space, as a part of a virtual spherical HUD system. More particularly, the three-dimensional stereographic space of the HUD system may be augmented with the enhanced data (or any data extracted from the obtained data feeds) to enable user interacting with the HUD device to view the object and/or region that was initially occluded from view.

Given unit position and orientation (such as latitude, longitude, elevation, & azimuth) from accurate global positioning systems or other navigation/orientation equipment, as well as data from accurate and timely elevation and/or topographical, or other databases, three dimensional layered occlusion volumes can be determined and displayed in three dimensions in real-time and shared amongst units where fully occluded spaces can be identified, weapons capabilities, weapons ranges, weapon orientation determined, and marked with weighted confidence level in real-time. Advanced real-time adaptive path planning can be tested to determine lower risk pathways or to minimize occlusion of unknown zones through real-time unit shared perspective advantage coordination. Unknown zones of occlusion and firing ranges can be minimized by avoidance or by bringing in other units to different locations in the region of interest or moving units in place to minimize unknown zones. Weapons ranges from unknown zones can be displayed as point ranges along the perimeters of the unknown zones, whereby a pathway can be identified so as to minimize the risk of being effected by weapons fired from the unknown zones.

FIG. 6 illustrates an example of a computing node 600 which may comprise an implementation of extra-sensory perception sharing system 12, according to various embodiments. The computing node 600 represents one example of a suitable computing device and is not intended to suggest any limitation as to the scope of use or functionality of embodiments of the invention described herein. Regardless, the computing node 600 is capable of being implemented and/or performing any of the functionality described above.

As illustrated, the computer node 600 includes a computer system/server 602, which is operational with numerous other general purpose or special purpose computing system environments or configurations. Examples of well-known computing systems, environments, and/or configurations that may be suitable for use with computer system/server 602 may include personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 602 may be described in the general context of computer system executable instructions, such as program modules, being executed by a computer system. Generally, program modules may include routines, programs, objects, components, logic, data structures, and so on that perform particular tasks or implement particular abstract data types. Computer system/server 602 may be practiced in distributed cloud computing environments where tasks are performed by remote processing devices that are linked through a communications network, In a distributed cloud computing environment, program modules may be located in both local and remote computer system storage media including memory storage devices.

As shown in FIG. 6, computer system/server 602 in computing node 600 is shown in the form of a general-purpose computing device. The components of computer system/server 602 may include one or more processors or processing units 604, a system memory 606, and a bus 608 that couples various system components including system memory 606 to processor 604,

Bus 608 represents one or more of any of several types of bus structures, including a memory bus or memory controller, a peripheral bus, an accelerated graphics port, and a processor or local bus using any of a variety of bus architectures. Such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 typically includes a variety of computer system readable media. Such media may be any available media that is accessible by computer system/server 602, and it includes both volatile and non-volatile media, removable and non-removable media.

System memory 606 may include computer system readable media in the form of volatile memory, such as random access memory (RAM) 610 and/or cache memory 612. Computer system/server 602 may further include other removable/non-removable, volatile/non-volatile computer system storage media. By way of example only, storage system 613 can be provided for reading from and writing to a non-removable, non-volatile magnetic media (not shown and typically called a “hard drive”). Although not shown, an optical disk drive for reading from or writing to a removable, non-volatile optical disk such as a CD-ROM, DVD-ROM or other optical media can be provided. In such instances, each can be connected to bus 608 by one or more data media interfaces. As will be further depicted and described below, memory 606 may include at least one program product having a set (e.g., at least one) of program modules that are configured to carry out the functions of embodiments of the invention.

Program/utility 614, having a set (at least one) of program modules 616, may be stored in memory 606, as well as an operating system, one or more application programs, other program modules, and program data. Each of the operating system, one or more application programs, other program modules, and program data or some combination thereof, may include an implementation of a networking environment. Program modules 616 generally carry out the functions and/or methodologies of embodiments of the invention as described herein.

Computer system/server 602 may also communicate with one or more external devices 618 such as a keyboard, a pointing device, a display 620, etc.; one or more devices that enable a user to interact with computer system/server 602; and/or any devices (e.g., network card, modem, etc.) that enable computer system/server 602 to communicate with one or more other computing devices. Such communication can occur via Input/Output (I/O) interfaces 622. Still yet, computer system/server 602 can communicate with one or more networks such as a local area network (LAN), a general wide area network (WAN), and/or a public network (e.g., the Internet) via network adapter 624. As depicted, network adapter 624 communicates with the other components of computer system/server 602 via bus 608. It should be understood that although not shown, other hardware and/or software components could be used in conjunction with computer system/server 602. Examples, include, but are not limited to: microcode, device drivers, redundant processing units, and external disk drive arrays, RAID systems, tape drives, and data archival storage systems, etc.

The embodiments of the present disclosure described herein are implemented as logical steps in one or more computer systems. The logical operations of the present disclosure are implemented (1) as a sequence of processor-implemented steps executing in one or more computer systems and (2) as interconnected machine or circuit engines within one or more computer systems. The implementation is a matter of choice, dependent on the performance requirements of the computer system implementing aspects of the present disclosure. Accordingly, the logical operations making up the embodiments of the disclosure described herein are referred to variously as operations, steps, objects, or engines. Furthermore, it should be understood that logical operations may be performed in any order, unless explicitly claimed otherwise or a specific order is inherently necessitated by the claim language.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

What is claimed is:

1. A method for identifying an unknown object in a space comprising:
receiving, by one or more computing devices, a plurality of data feeds from a plurality of plurality of sensors, the plurality of data feeds capturing data corresponding to at least one object obstructed from view in a first three-dimensional stereographic space displayed at an interface;
selecting, by the one or more computing devices, respective data feeds from the plurality of data feeds; and
generating, by the one or more computing devices, a second three-dimensional stereographic space for display at the interface, wherein the second three-dimensional stereographic space includes a rendering of the at least one object, portions of the rendering based on the respective data feeds.

2. The method of claim 1, wherein the three-dimensional stereographic space corresponds to a real-world environment, the method further comprising:
determining an orientation of the interface displaying the first three-dimensional stereographic space, the orientation defining a point-of-view of a user interacting with the interface, and
wherein the second three-dimensional stereographic interface is generated based on the orientation.

3. The method of claim 1, wherein the real-world environment is mountainous terrain, and wherein the interface is a head-mountable device.

4. The method of claim 1, further comprising weighting each data feed of the plurality of data feeds based on a weighting threshold quantifying the accuracy of respective data feed at certain point in time.

5. The method of claim 3, wherein selecting respective data feeds from the plurality of data feeds comprises identifying the respective data feeds with a particular weighting that satisfy a weight threshold.

6. The method of claim 2, further comprising:
providing for display at the interface, geographic location information corresponding to the at least one object, the geographic location information uniquely identifying the at least one object from the perspective of the point-of-view of the user.

7. The method of claim 1, wherein the second three-dimensional stereographic space is generated in real-time.

8. The method of claim 1, wherein the respective data feeds includes at least two data feeds, the further comprising:
processing the at least two data feeds to generate enhanced data including a specific geographic location corresponding to the at least one object and an identification of the at least one object; and
wherein the rendering of the at least one object is also based on the enhanced data.

9. The method of claim 1, wherein the plurality of data feeds are at least one of a global positioning data feed, a radio data feed, a video data feed, an early warning and control system data feed, and an audio data feed providing at least one of tactical data, three-dimensional environmental data, three-dimensional weather data, or three-dimensional terrain data corresponding to the at least one object.

10. The method of claim 1, further comprising providing the second three-dimensional stereographic to an extra-sensory perception sharing system located near the interface.

11. A system for identifying an unknown object in a space comprising:
at least one computing device to:
receive a plurality of data feeds from a plurality of plurality of sensors,
the plurality of data feeds capturing data corresponding to at least one object obstructed from view in a first three-dimensional stereographic space displayed at an interface;
select respective data feeds from the plurality of data feeds; and
generate a second three-dimensional stereographic space for display at the interface, wherein the second three-dimensional stereographic space includes a rendering of the at least one object, portions of the rendering of the at least one object based on the respective data feeds.

12. The system of claim 11, wherein the three-dimensional stereographic space corresponds to a real-world environment, and wherein the at least one computing device is further configured to:
determining an orientation of the interface displaying the first three-dimensional stereographic space, the orientation defining a point-of-view of a user interacting with the interface,
wherein the second three-dimensional stereographic interface is generated according to the orientation.

13. The system of claim 11, further comprising weighting each data feed of the plurality of data feeds based on a weighting threshold quantifying the accuracy of respective data feed at certain point in time.

14. The system of claim 13, wherein selecting respective data feeds from the plurality of data feeds comprises identifying the respective data feeds with a particular weighting that satisfy the weight threshold.

15. The system of claim 11, further comprising providing for display at the interface, geographic location information corresponding to the at least one object, the geographic location information uniquely identifying the at least one object from the perspective of the point-of-view of the user.

16. The system of claim 11, wherein the second three-dimensional stereographic space is generated in real-time.

17. The system of claim 11, wherein the plurality of data feeds are at least one of a global positioning data feed, a radio data feed, a video data feed, an early warning and control system data feed, and an audio data feed providing at least one of tactical data, three-dimensional environmental data, three-dimensional weather data, or three-dimensional terrain data corresponding to the at least one object.

18. The system of claim 11, wherein the respective data feeds includes at least two data feeds, and wherein the at least one computing device is further configured to:
process the at least two data feeds to generate enhanced data including a specific geographic location corresponding to the at least one object and an identification of the at least one object, wherein the rendering of the at least one object is based on the enhanced data.

19. The system of claim 12, wherein the interface is a head-mountable device comprising:
a display surface for displaying the first three-dimensional stereographic space and the second three-dimensional stereographic space;
at least one sensor positioned to optically track a direction of at least one eye of a user interacting with the interface;
at least one head orientation sensor to track a head movement of the user; and
wherein the direction and head movement of the user are processed by the at least one processor to determine the orientation of the user;

20. A system for identifying an unknown object in a space comprising:
a head-mountable device comprising a display surface, the head-mountable device in operable communication with at least one processor, the at least one processor to:
receive a plurality of data feeds from a plurality of plurality of sensors, the plurality of data feeds capturing data corresponding to at least one object obstructed from view in a first three-dimensional stereographic space displayed at the display surface;
automatically select respective data feeds from the plurality of data feeds; and
generate a second three-dimensional stereographic space for display at the display surface, wherein the second three-dimensional stereographic space includes a rendering of the at least one object, portions of the rendering of the at least one object based on the respective data feeds.
